(19) United States
(12) Patent Application Publication
(10) Pub. No.: US 2014/0032544 A1
(43) Pub. Date: Jan. 30, 2014

(54) Method for refining the results of a search within a database

(71) Applicant: XILOPIX, Epinal (FR)

(72) Inventors: Eric Mathieu, Paris (FR); Cyril March, Les Rouens (FR)

(73) Assignee: XILOPIX, Epinal (FR)

(21) Appl. No.: 13/987,997

(22) Filed: Sep. 23, 2013

Related U.S. Application Data
(63) Continuation of application No. PCT/FR2012/050576, filed on Mar. 19, 2012.

(30) Foreign Application Priority Data
Mar. 23, 2011 (FR) 11/52383

(51) Int. Cl. G06F 17/30

(52) U.S. Cl. CPC G06F 17/3053
USPC 707/728

(57) ABSTRACT

A method refines the results of a search for objects within a database containing a set of objects each associated with a descriptor. The method includes a step of presenting to a user the set of objects, and a part of the objects is associated with a clickable image for a user to signal the relevance or non-relevance of the said object in relation to the user's search. The method further includes a step of assigning a weight to descriptors of an object and another step of calculating a resultant of the weights. The calculating step is followed by the step of initializing a relevance index for each result object and the step of comparing each result object to the resultant and presenting to the user the result objects in the order of relevance index.

### CROSS-REFERENCE TO RELATED APPLICATIONS

This application is a continuation of International Application No. PCT/FR2012/050576, filed on Mar. 19, 2012, which claims the benefit of FR 11/52383, filed on Mar. 23, 2011. The disclosures of the above applications are incorporated herein by reference.

### FIELD

The present disclosure relates to a method for refining the results of a search in a database containing a set of objects.

### BACKGROUND

The statements in this section merely provide background information related to the present disclosure and may not constitute prior art.

The development of digital technologies in recent years, accompanied with the development of networks and the Internet has led to a markedly significant increase in the amount of digital content available.

A particularly significant example thereof is the development of digital photography, in particular on account of the development of online publishing sites and photo sharing site. Thus, in September 2010 one of the leaders among such types of sites exceeded the five billion mark in terms of number of photos posted online and has since then continued to add several thousands more online per day.

These digital objects are usually listed in the database in association with key words and/or other technical descriptors (size, resolution, etc). These keywords and descriptors make it possible to perform searches of the database and to return the objects whose keywords match the search criteria entered by a user in a search field.

Currently, however, most of the search engines have been primarily designed to enable searching for text within web pages or files, and in particular in associated description texts.

In the event that the stored objects are not textual in nature, such as photographs, for example, the keywords and associated descriptors become considerably more important for enabling an efficient search to be performed followed by a relevant search result being returned.

Numerous search engines exist that allow for such searches to be carried out, and many algorithms have been developed in order to optimise the relevance of the results of these searches.

Despite the fairly sophisticated algorithms, a keyword search has inherent limitations, in particular, for example due to the existence in the human language of synonyms, homonyms, hierarchy in terms, and degree of accuracy.

By virtue of these limits, the intention of the user's specific search beyond the primary meaning of the keywords used remains unknown to the search engine.

In order to overcome these limitations, the majority of search engines allow users to perform an advanced search, particularly by using multiple keywords that may be combined with the use of Boolean operators.

Such a process for carrying out a search is, however, not particularly easy for the user and may, on certain search engines, amount to requiring almost programming level skills to write a query, while not knowing whether this query could be correctly interpreted by the engine and lead to the desired result.

Thus, there is a need that justifies the development of a method for optimising the searches for objects contained in a database and in particular for overcoming certain ambiguities or inaccuracies so as to better respond to the user's query.

### SUMMARY

The present disclosure provides a method for refining the results of a search for objects within at least one database containing at least one set of objects each associated with at least one descriptor, the said method comprising steps of:

presenting to a user all or part of a set of objects of database, at least one part of the objects presented being each associated with at least one means for a user to signal the relevance and/or at least one means for the user to signal the non-relevance of the said object in relation to their search;

as a function of the signaling from the user, assigning at least one weight to all or part of the descriptors of an object from the set of objects presented that are considered by the user to be relevant and/or non-relevant to their search;

calculating a resultant of the weights associated with each descriptor of the set of result objects;

initializing a relevance index for each result object;

comparing each result object to the resultant, and for each descriptor of the result object compared, increase or decrease the relevance index of the object as a function of the weight of this descriptor in the resultant; and

presenting to the user all or part of the result objects in the order of their relevance index calculated.

Thus by allowing the user to directly signal whether they find the results of an initial search to be relevant or not relevant, it is possible to better take into account the real meaning of their search and to provide them with a more satisfactory result. Moreover, with such a method, it is easy for the user to perform a complex search by adding or removing descriptors and keywords, which is done in an intuitive and transparent manner.

The term ‘object’ refers to any digital object that can be stored in a database. As stated above, it may in particular be photographs, as well as other types of files including audio, video, documents, etc.

It should be noted that, according to the operating principles of a database, the referenced objects themselves are not necessarily contained directly in a record in the database and may very well be referenced by way of their storage address or URL, for example, or via any other indirect means.

It should also be noted that the term descriptor used is not limited. The term descriptor obviously includes descriptors such as keywords, but it could refer also to more technical descriptors referencing textures, materials, color profiles, definition, etc. It could also be semantic descriptors established based on a thesaurus. The nature of the descriptors is generally not limited and they may be adapted depending upon the objects that are referenced in the relevant databases, and searched.

It should also be noted that different weights can be assigned to different descriptors, in particular as a function of their origin, context, and situation in relation to all of the other descriptors. Thus, for example, the descriptors from a thesaurus, and therefore having a standardized, uniform and structured nature, may have greater weight than that of the keyword type descriptors that have been assigned by the users of a photo sharing site themselves.

Several unexpected and surprising beneficial effects have been observed. It is especially clear that the method of the present disclosure allows for the user to overcome to some extent issues arising from the language of textual descriptors used. In effect, from an initial search in their own language, the user by using the method according to the present disclosure to refine the search results can also assign a weight in a transparent manner to descriptors and keywords in the foreign language associated with the object. The search could therefore ultimately become refined on the basis of key words in a foreign language, or at least by taking them into account, the foreign language being one that the user does not necessarily understand and which they would not have entered directly into a text based search engine.

In one form, the set of objects initially presented to the user corresponds to all or part of the objects resulting from an initial search, in particular by keyword, in the database or databases. Quite obviously, all modes of initial search that allow for generating a first set of objects are possible. In addition to a conventional search using a text field and an entry of words by the user, one can imagine a selection of objects directly from geographic coordinates on a map, or even a first photo that would, for example, be analyzed in order to extract therefrom search parameters, etc.

Depending on the number of objects returned by this initial search, it could be chosen to present to the user only a part of the results, for example the first ten thousand photographs of a search by keywords in a database of photos.

It should also be noted that the search in the database or databases may be performed in an internal database, but also on external databases hosted on remote specialized sites, for example.

It could also be chosen to not proceed with an initial keyword search and to present the user with a set of objects representative of major categories of the database, for example. The user would then be free to navigate through the database by successively refining their selections with the aide of the method that is the subject matter of the present disclosure.

In another form, the objects of the set of objects initially presented to the user are presented in a defined order when obtaining said set of objects, in particular in an order of relevance in relation to the initial search, this relevance can in particular be defined by a search algorithm. Indeed, the conventional search engines frequently associate a relevance index to their search results.

Alternatively or in a complementary manner, the order of relevance and initial presentation may be defined in an ad hoc manner in order to, for example, maximize the number of different objects initially presented so as to allow the widest possible choice to the user for their first refinement process and eventually for the subsequent ones.

In still another form, the weights assigned to the descriptors of objects considered to be non-relevant and the weights assigned to the descriptors of the objects considered to be relevant, have opposite signs, and more particularly, they have respectively negative and positive signs.

Quite obviously, this simply involves a rating scale given by way of example, the point of reference not necessarily being zero, it being possible to select other reference points without any difficulty with this simply constituting a shift of the scale. In this case, it should be considered that the terms “opposite sign”, “positive” and “negative” shall be understood in relation to this reference point.

According to a first variant, the absolute values of the weights assigned to the descriptors of the objects considered to be relevant and/or non-relevant are equal.

According to a second variant, the weight assigned to the descriptors of the objects considered to be relevant have an absolute value that is different, and in particular higher, than the weight assigned to the descriptors of the objects considered to be non-relevant.

Advantageously, the values of the weights assigned to the descriptors of the objects considered to be relevant and/or non-relevant may be different for each object signaled.

Still advantageously, the value of the weights assigned to the descriptors of the objects considered to be relevant and/or non-relevant is a function of their initial order of priority. In particular a coefficient could be applied to a value of standard weight. For example, an object considered to be relevant to 90% par the search engine that carried out the initial search could be found to be attributed 90% of the value of the reference weight if this object is considered to be relevant by the user.

However, if the user considers it to be non-relevant, unlike the search engine, one could choose to assign to it only 10% of the reference value of the non-relevant weight.

According to an advantageous form, the means for signaling the relevance and/or non-relevance of an object presented consists of the means suitable for signaling different degrees of relevance and/or non-relevance that allow for, in particular the assigning of a different weight according to the degree of relevance and/or non-relevance signaled. Thus, one could in particular provide a web page including buttons to be used to report that an object is, for example, “very relevant” (first degree), “relevant” (second degree), “somewhat relevant” (third degree) “not relevant” (fourth degree) and “off topic” (fifth degree).

Advantageously, the result objects are presented in the form of previews, thumbnails and/or excerpts.

According to a particular form, the objects contained in the database include photographs, video, and or audio objects. There may also be other types of documents, text files, etc.

According to a first form, the relevance index is initialized to the same value for each result object, in particular to zero.

According to a second form, the relevance index is initialized to different values for all or part of the result objects, in particular as a function of the initial order of presentation and, as appropriate, of a relevance value returned by the initial search.

According to a more advanced form, all or part of the descriptors of the most relevant objects returned feed a new search in the database.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a screen shot of a website that has practically implemented the method according to the present disclosure, at the level of the first step presenting to a user the results of an initial search by keyword;

FIG. 2 is a screen shot of the website in FIG. 1 wherein a user has signaled a photo that they consider to be relevant to their search;

FIG. 3 is a screen shot of the website in FIG. 1 wherein a user has signaled a photo that they consider to be non-relevant to their search;

FIG. 4 is a screen shot after the triggering of the step of refining the search by the user;

FIG. 5 is a screen shot of the website in FIG. 1 showing the result of the step of refining carried out on the basis of the signals indicative of relevance and non-relevance by the user; and

FIG. 6 is a flowchart schematically illustrating the practical operation of the process illustrated in FIGS. 1 to 5.

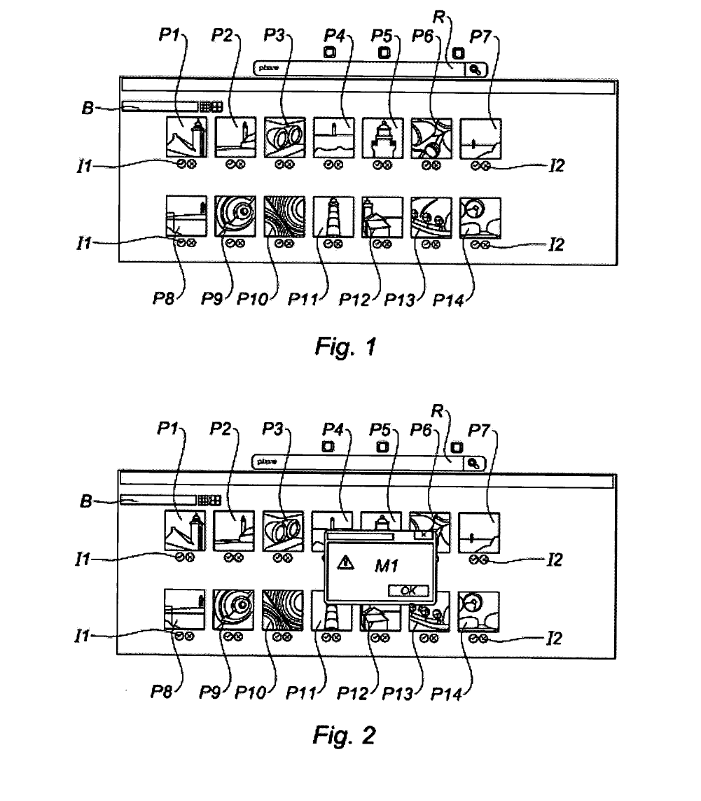

With reference also to FIG. 6, FIGS. 1 to 5 show screen shots of a web site that has practically implemented the method according to the present disclosure on a search for photos of car headlights.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

FIG. 1 shows a first step 101 in which a set of thumbnails of photos P1 to P14 is presented to the user.

This set of photos P1 to P14 has been obtained through an initial search by keyword in one or more databases of photos.

In this case, the keyword in French “phare” was used by the user in order to define the search and keyed in into a search field R of the page.

The search field R serves as interface with the user and feeds a search engine that may be internal or external to the site, in the databases of photos. Such data bases include a great number of photos and associate therewith various descriptors for the purposes of facilitating further searches. These descriptors include in particular lists of keywords, but may also be parameters specific to the photo (photograph used, technical data, color profile, etc).

Quite understandably, the use of one single keyword “phare” is naturally a source of ambiguity and carries different meanings in French that the search engine would not be able to resolve.

The search engine therefore returns the results of its search algorithm and presents them to the user in the form of fourteen thumbnail photographs P1 to P14.

It should be noted that the fourteen photographs presented to the user do not necessarily correspond to the full results of the initial search and it is quite possible to choose to present to the user only a part of the results, for example the first thousand photographs returned.

As shown in FIG. 1, the photographs P1, P2, P4, P5, P7, P8, P9, P11, P12 refer to photographs of coastal lighthouses for navigation.

With respect to photos P3, P6, P10, P13, P14, these however, relate to photographs of car headlights.

Each photo is associated, in the database that contains it or in another database, with one or more descriptors.

For the purposes of this example, we assume that the photographs P1, P2, P4, P5, P7, P8, P9, P11, P12 are associated with a French keyword descriptor “phare”, and the photos P3, P6, P10, P13, P14 are each associated with two French descriptors “ phare” and “ voiture” (car).

In accordance with the method according to the present disclosure, photographs P1 to P14 are each presented to the user in association with a clickable image I1 representing a ‘check mark’ of validation and a clickable image 12 representing a ‘cross out mark’ of rejection.

These clickable images are associated with computing functions recording the user's choice and constituting the means for said user to signal the relevance (check mark) and/or non-relevance (cross out mark) of each photograph in relation to their actual search.

It is quite obvious that the images of a check mark and a cross out mark are given merely by way of an example and that any equivalent representation is possible, including clickable text informing the user of the choice that he has.

The user then proceeds during a step 102 to the signaling of the photographs that they consider to be relevant and/or non-relevant.

FIG. 2 is a screen shot showing that the user signaled that the photograph P14 was relevant to their actual search. A message M1 informs them that their signaling has properly been taken into consideration by the website or software.

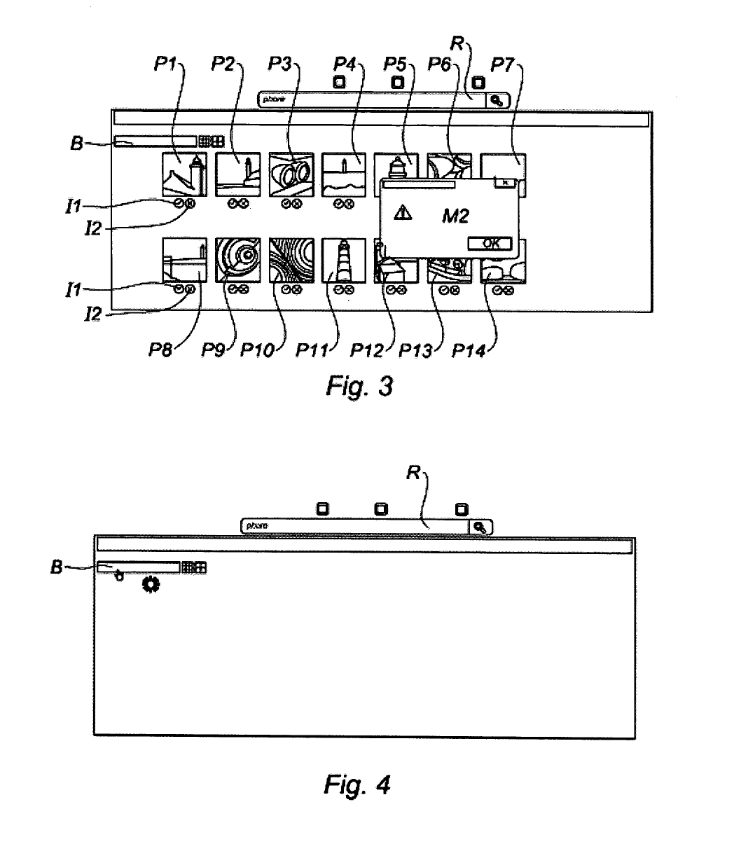

FIG. 3 is a screen shot showing that the user has signaled that the photograph P4 was not relevant to their actual search since it shows a coastal lighthouse. A message M2 informs them that their signaling has properly been taken into consideration by the website or software.

In this present example, the messages M1 and M2 are displayed in the form of “pop-up” messages (display of an overlay window). It is quite evident that these messages may be signaled to the user in other forms, in particular, by a grouping together of the images selected, a display in a sidebar, the setting up of virtual carts for the images selected as relevant and non-relevant, etc.

When the user has finished selecting the photos that they consider to be relevant and/or non-relevant to their search, they activate the process of refining the search by clicking, for example, on a button B. An example of a processing screen is shown in FIG. 4.

Quite obviously the refining process can also take place in real time based on interactions of the user, this would however, require greater processing resources and support of a remote server in particular. The processing steps are transparent to the user.

During a step 103, a weight P is associated with each descriptor associated with each image signaled by the user. The weight P is assigned a negative sign if the image has been signaled as non-relevant and a positive sign if the image has been signaled as relevant.

In the example provided, the photograph P4, which has a descriptor “phare” associated, has been signaled as non-relevant and the photograph P14, which has two descriptors “phare” and “voiture” associated, has been signalled as relevant.

Thus, the descriptor “phare” is assigned a weight −P on account of the non-relevance signaled for the photograph P4 and is assigned a weight +P on account of the relevance signaled for the photograph P14.

Similarly, the descriptor “voiture” is assigned a weight +P on account of the relevance signaled for the photograph P14.

A resultant of the weights assigned to each descriptor of the set of images P1 to P14 is calculated during the course of a step 104.

In this case, the descriptor “phare” thus gets an overall weight of null, while the descriptor “voiture” gets an overall weight equal to +P.

The resultant is the set of descriptors of the photographs P1 to P4 assigned their respective weights as calculated previously.

Prior to proceeding to the refining and sorting of the objects presented, a relevance index is associated with each photo P1 to P14 and initialized to zero during a step 105.

Each photograph P1 to P14 therefore has the same priority and relevance.

A step 106 is then carried out to compare each photograph P1 to P14 with the resultant of the weights of the descriptors.

In order to do this, each descriptor of the photograph P1 to P14 is compared to the resultant, and the priority index is increased or decreased by the weight of the descriptor in the said resultant.

Thus, the photograph P1, showing a coastal lighthouse, and having only the descriptor “phare”, gets its priority index increased by the weight of the descriptor “phare” in the resultant, that is by zero. Its priority index therefore remains at zero. The same holds true for the photograph P2.

The photograph P3 however shows car headlights. As mentioned earlier, it is associated with two descriptors “phare” and “voiture”. For the descriptor “phare”, its index does not change, since the weight of this descriptor is null. However, for the descriptor “voiture”, its priority index is increased by the weight of the descriptor “voiture” in the resultant, that is by +P. Its priority index thus becomes +P. One proceeds in the same manner for photos P4 to P14.

It suffices thus to simply rearrange the photos P1 to P14 based on their respective newly calculated priority index and to display them in the order of their declining relevance index during a step 107 in order for the photos of car headlights to be displayed first and followed subsequently by those of coastal lighthouses.

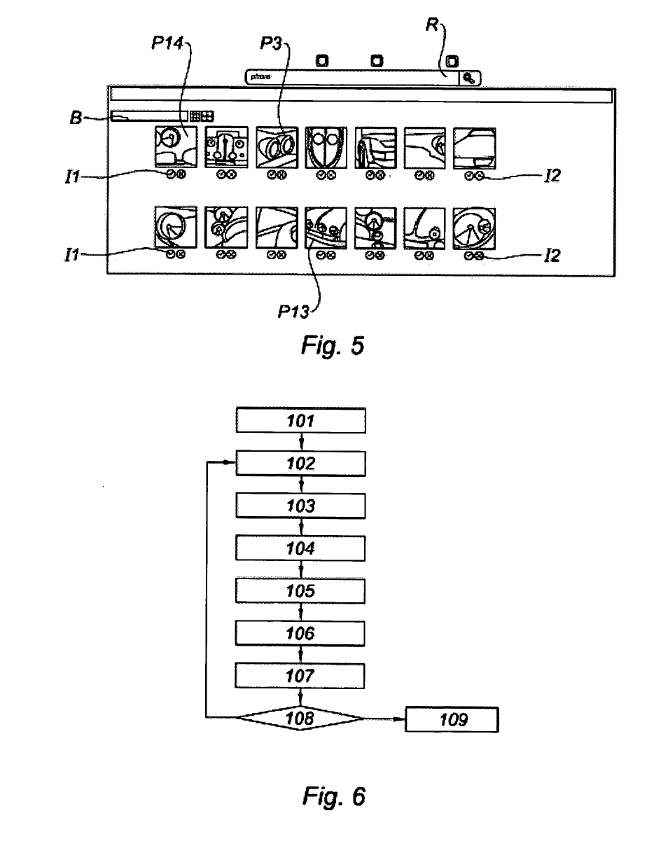

FIG. 5 shows a screen shot presenting the final rearrangement where only photographs of car headlights are properly presented.

It should be noted that FIG. 5 also shows the photos that were not present on the initial presentation screen. Indeed, it is quite possible to select a batch of initial photos that is larger than the batch of fourteen photographs presented, with some photographs then being hidden from the user. However, they are present in the initial selection and are taken into consideration for the implementation of the process. Therefore they also receive a relevance index that changes their order in the selection. In the end, they may thus be found amongst the first fourteen photos, and therefore be presented to the user.

As regards the initial photographs of lighthouses, these are relegated to beyond the fourteenth photo and therefore no longer appear.

Quite obviously, the user can then perform a new refinement of their search, particularly if new photos have been presented to them (step 108) or stop their search (step 109).

Although the present disclosure has been described with a particular example of form, it is quite obvious that it is in no way limited and includes all technical equivalents of the means described as well as their combinations if these latter are within the scope of the present disclosure.

This may in particular include the provision of additional means of signaling, for example a “neutral” button in addition to the means used to signal the characteristics of relevance and/or non-relevance.

It could also be possible to provide for a means for reinitializing the weights and relevance index in the event of the user making an error or wishing to begin a search refinement process in accordance with other criteria.

Moreover, although the present disclosure has been described with respect to photos, it is very obviously not limited to these, and any other type of digital file with which descriptors may be associated can be utilized for its implementation. It would be possible therefore to implement the method in the same manner with audio files, in particular associated with descriptors with respect to their musical style, the nature of sound, their instruments, etc., but also with other types of files including videos, animated images, documents, text files, in particular scanned old books, etc.

What is claimed is:

1. A method for refining results of a search for objects within at least one database containing at least one set of objects each associated with at least one descriptor, the said method comprising steps of:
presenting to a user all or part of a set of objects of the database, at least one part of the objects presented being each associated with at least one means for the user to signal relevance and/or at least one means for the user to signal non-relevance of the said object in relation to the user's search;
assigning, as a function of the signaling from the user, at least one weight to all or part of the descriptors of an object from the set of objects presented that are considered by the user to be relevant and/or non-relevant to the user's search;
calculating a resultant of the weights associated with each descriptor of the set of result objects;
initializing a relevance index for each result object;
comparing each result object to the resultant, and for each descriptor of the result object compared, increasing or decreasing the relevance index of the object as a function of the weight of this descriptor in the resultant; and
presenting to the user all or part of the result objects in the order of the relevance index calculated.

2. The method according to claim 1, wherein the set of objects initially presented to the user corresponds to all or part of the objects resulting from an initial search in the database or databases.

3. The method according to claim 2, wherein the initial search is a keyword search.

4. The method according to claim 1, wherein the objects of the set of objects initially presented to the user are presented in a defined order when obtaining said set of objects.

5. The method according to claim 4, wherein the defined order is an order of relevance in relation to the initial search.

6. The method according to claim 5, wherein the relevance is defined by a search algorithm.

7. The method according to claim 1, wherein the weights assigned to the descriptors of objects considered as being non-relevant and the weights assigned to the descriptors of the objects considered as being relevant, have negative and positive signs respectively.

8. The method according to claim 1, wherein absolute values of the weights assigned to the descriptors of the objects considered as being relevant and/or non-relevant are equal.

9. The method according to claim 1, wherein the weight assigned to the descriptors of the objects considered to be relevant have an absolute value that is different from an absolute value of the weight assigned to the descriptors of the objects considered as being non-relevant.

10. The method according to claim 9, wherein the weight assigned to the descriptors of the objects considered to be relevant has a higher absolute value than that of the weight assigned to the descriptors of the objects considered to be non-relevant.

11. The method according to claim 1, wherein values of the weights assigned to the descriptors of the objects considered to be relevant and/or non-relevant are different for each object signaled.

12. The method according to claim 11, wherein the value of the weights assigned to the descriptors of the objects considered to be relevant and/or non-relevant is a function of their initial order of priority.

13. The method according to claim 1, wherein means for signaling the relevance and/or non-relevance of an object presented consists of a means suitable for signaling different degrees of relevance and/or non-relevance that allow for the assigning of a different weight according to the degree of relevance and/or non-relevance signaled.

14. The method according to claim 1, wherein the result objects are presented in at least one form of previews, thumbnails, and excerpts.

15. The method according to claim 1, wherein the objects contained in the database include at least one of photographs, video, and audio objects.

16. The method according to claim 1, wherein the relevance index is initialized to a same value for each result object.

17. The method according to claim 16, wherein the same value is zero.

18. The method according to claim 1, wherein the relevance index is initialized to different values for all or part of the result objects, as a function of the initial order of presentation and, as appropriate, of a relevance value returned by the initial search.

19. The method according to claim 1, wherein all or part of the descriptors of most relevant objects returned feed a new search in the database.
